(19) United States
(12) Patent Application Publication
(10) Pub. No.: US 2011/0056805 A1
(43) Pub. Date: Mar. 10, 2011

(54) MOVING FLOOR HYDRAULIC ACTUATOR ASSEMBLIES

(75) Inventors: Travis V. Schmidt, Oregon CIty, OR (US); Lynn A. Stuart, Happy Valley, OR (US)

(73) Assignee: Hydra-Power Systems, Inc., Portland, OR (US)

(21) Appl. No.: 12/563,749

(22) Filed: Sep. 21, 2009

Related U.S. Application Data
(60) Provisional application No. 61/239,925, filed on Sep. 4, 2009.

(51) Int. Cl. B65G 25/08; B65G 25/04

(52) U.S. Cl. 198/750.5; 91/189 R; 91/189 A; 91/361

(57) ABSTRACT

A hydraulic moving floor actuator in a slat-type reciprocating moving floor system having movable floor slats arranged side-by-side in parallel, with each slat extending longitudinally along a conveyance path and interconnected with other slats to form groups of slats which may be extended or retracted in unison or one group at a time, that includes a fluid power cylinder controllably moving each group of interconnected slats and hydraulic circuitry that provides fluid communication between the rod side and the head side of each cylinder and causes extension of the cylinder when pressurized hydraulic fluid acts simultaneously upon the rod and head sides of the cylinder. In preferred embodiments, the actuator includes cylinders machined into a substantially unitary manifold, integrated electronic controls, embedded electronic piston position sensors, automatic jamming detection and automatic reverse for clearing jamming conditions, and other features not found in heretofore available slat-type moving floor systems.

### RELATED APPLICATIONS

This application claims the benefit of U.S. Provisional Application No. 61/239,925, filed Sep. 4, 2009.

### BACKGROUND OF THE INVENTION

This disclosure relates to hydraulic and electro-hydraulic actuator assemblies for slat-type reciprocating conveyors or moving floors, and, more particularly, to hydraulic and/or electro-hydraulic circuitry for controllable operation of slat-type moving floor systems.

A slat-type moving floor is generally a hydraulically-driven reciprocating conveyor that uses groups of interconnected floor slats to move a load along a linear path. Typically, the moving floor consists of movable floor slats arranged side-by-side in parallel, with each slat extending longitudinally along the length of a conveyance surface such as a tractor trailer floor. The floor slats are typically divided into three groups of slats, with every third slat interconnected to one another and to one of three cross-drive members, with the cross-drive members hydraulically-driven to extend together in unison to move the load forward and to retract one at a time. A load resting upon the floor slats may be conveyed longitudinally along the floor slats by first extending all slats in the desired direction of travel, retracting the slats one group at a time until all three groups of slats have been retracted to their original starting position, and repeating the sequence until the load has been moved to its desired location.

The friction between the load and the stationary slats resists movement of the load while the retracting slats return to their unextended or starting position. More or less groups of slats may be used, but most systems use three groups of slats with each group driven by a hydraulic fluid power actuator such as a piston and cylinder assembly. Such moving floor systems are sometimes referred to as three-cylinder systems. Conceptually, four groups of slats may be used, with all four groups extending in unison to move a load in the desired direction of travel. From an extended position, the slats may then be retracted one group at a time. However, the additional cylinder(s), associated cross-drive member, and other components needed for systems using more than three cylinders render such systems less practical.

Two-cylinder systems have been developed. One such system uses two groups of slats, with each group driven by a hydraulic fluid power actuator, and mechanical means for lowering or raising one group of slats at a time. For example, such system may include means for raising one group of slats at a time (with the load thereupon) while the other group of slats is retracted. Or such system may include means for lowering one group of slats at a time while the other group of slats (with the load thereupon) is extended.

Another two-cylinder system uses non-movable or static slats positioned between the movable slats, for example a narrower static slat between each movable slat or pair of independently movable slats. The load-contacting surface area of the narrower static slats provide enough friction when combined with the surface area of the non-moving group of slats to substantially prevent the load from moving when one of the movable groups of slats is retracted.

Single-cylinder systems may be possible. Conceptually, such systems may use non-longitudinally-movable or longitudinally static slats positioned between slats of a single group of longitudinally movable slats, the longitudinally movable slats driven by a hydraulic fluid power actuator, and mechanical means for alternately lowering and raising either the longitudinally movable group of slats or the non-longitudinally-movable ones. For example, the longitudinally movable slats may be configured so as to raise (with the load thereupon) to above the level of the longitudinally static slats when extending and then lower (allowing the load to rest upon the longitudinally static slats) when retracting. Or, alternatively, the longitudinally static slats may be configured to lower into a lowered position when the longitudinally movable slats (with the load thereupon) are extended and to raise into a raised position (lifting the load from the longitudinally movable slats) when the longitudinally movable slats are retracted.

Slat-type moving floors may be used for moving a wide variety of material, from bulk material such as shredded tires or refuse to palletized product, in warehouse, loading, semi-trailer or other applications. A moving floor-equipped trailer, for example, allows for unloading of the trailer without requiring the use of forklifts or other material handling equipment to extract the load, or without the need for tipping the floor of the trailer to dump the load. Prior moving floor-equipped trailers, however, employ so-called three-cylinder slat-type moving floor systems that use a set of three cylinders for actuation of the floor for movement of the load in one direction (i.e. for unloading a trailer) but require (if equipped) a second set of three oppositely oriented cylinders for actuation of the floor for movement of the load in the opposite direction (i.e. for loading).

Although different slat-type moving floor systems have been developed, most incorporate less-than-desirable actuator assembly designs requiring multiple hydraulic connections and comprising multiple separate parts, which in turn increases the number of failure modes and disadvantages with such systems. Other actuator assembly designs have been rejected in the marketplace due to poor quality or poor design, a lack of available features, difficulty of use, or other factors.

What is needed, therefore, are moving floor actuator assembly designs that offer features, capabilities, and improvements which are unavailable in actuators currently designed systems.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 is an exemplary slat-type moving floor system incorporating an electro-hydraulic actuator assembly, according to one embodiment.

FIG. 2 is a perspective partially transparent view of an exemplary electro-hydraulic actuator assembly as in FIG. 1, according to one embodiment.

FIG. 3 is an exemplary hydraulic circuit for an electro-hydraulic actuator assembly as in FIGS. 1 and 2, according to various embodiments.

FIG. 4 is an exemplary partial cross-sectional view of an electro-hydraulic actuator assembly as in FIG. 2, according to one embodiment.

### DETAILED DESCRIPTION OF PREFERRED EMBODIMENTS

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

Various operations will be described as multiple discrete steps performed in turn in a manner that is helpful for understanding the present invention. However, the order of description should not be construed as to imply that these operations are necessarily performed in the order they are presented, nor even order dependent.

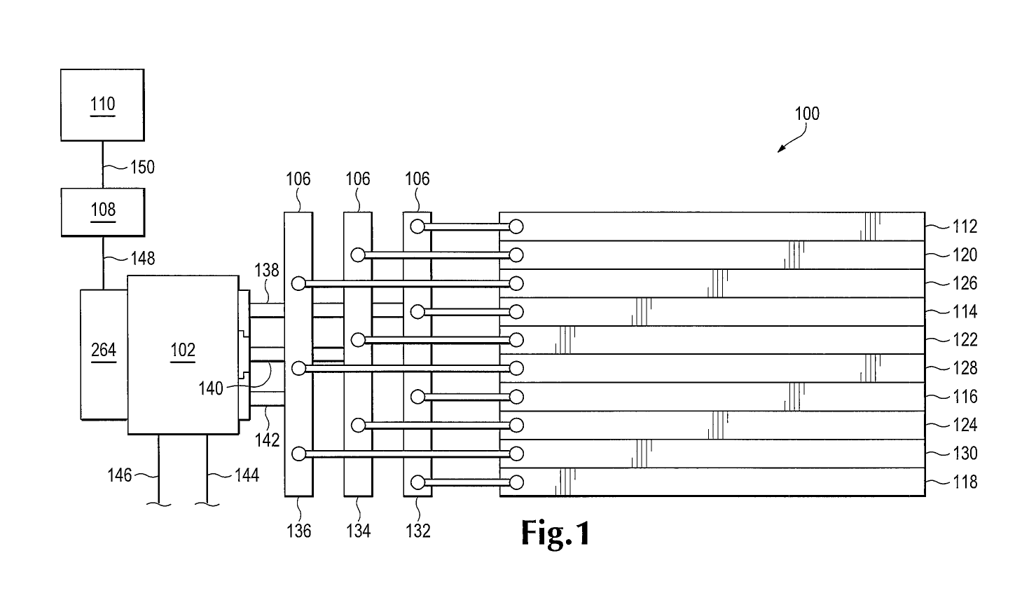

By way of general overview and as shown in FIG. 1, an exemplary slat-type moving floor system 100 incorporating a hydraulic moving floor actuator assembly 102, according to one embodiment, may comprise a load-conveying side-by-side (or parallel) arrangement of floor slats 104 upon which a load may be conveyed longitudinally along the slats as the slats reciprocate between a retracted position and an extended position via mechanical linkages to cross drives 106, which are in turn hydraulically driven by the moving floor actuator assembly 102. The moving floor actuator assembly 102 may be controlled by a control console 108 or other control device.

The system shown in FIG. 1 includes an arrangement of floor slats 104 having every third floor slat interconnected to one another to form a group of slats that may be extended and retracted together as a group. As shown, slats 112, 114, 116, and 118 are interconnected to one another via a cross drive member 132; slats 120, 122, and 124 are interconnected to one another via a second cross drive member 134; and slats 126, 128, and 130 are interconnected to one another via a third cross drive member 136. Each of the three cross drives (such as cross drives 132, 134, and 136) is hydraulically driven by a separate longitudinally extensible piston rod (such as piston rods 138, 140, and 142, respectively) extending from the moving floor actuator assembly 102, which in turn includes hydraulic fluid power cylinders and hydraulic and/or electro-hydraulic circuitry for controlling the longitudinal extensible position and movement of the piston rods. The moving floor actuator assembly 102, as shown, receives pressurized hydraulic fluid via pump conduit 146, returns hydraulic fluid via tank conduit 144, and preferably receives electrical power and control signals via line 148. In one embodiment a power source 110 (such as a 12 or 24 volt battery supply) may provide the electrical power to the control console 108 via line 150. Other sub-systems (not shown) may include a power cooling assembly used for conditioning hydraulic fluid provided by a hydraulic pump coupled to, for example, a vehicle engine power-take-off (PTO) unit, a gas engine, a diesel engine, or an electric motor.

Although the moving floor actuator assembly 102 is shown and described in the context of a slat-type moving floor system having three groups of interconnected floor slats with each group hydraulically driven by one of three hydraulic fluid power cylinders, less preferred embodiments may employ a moving floor actuator assembly 102 with fewer than three hydraulic fluid power cylinders (for moving floor systems using few than three groups of interconnected floor slats) or more than three hydraulic fluid power cylinders (for moving floor systems using more than three groups of interconnected floor slats). The moving floor actuator assembly 102 is preferably, as shown, a substantially unitary (or integrated) device with a minimum of exposed or external hydraulic line connections and having electronics and hydraulic valving enclosed within the integrated device. Preferably, the moving floor actuator assembly 102 comprises a manifold that includes: hydraulic fluid power cylinders machined into the manifold; embedded electronic piston position sensors; screw-in, cartridge-type solenoid-controlled two-way valves; and an enclosed electronic controller for controlling the two-way valves in response to 1) piston position sensed by the piston position sensors (thereby providing automatic anti-jamming of the moving floor system) and 2) a user selection of desired operation such as, for example, forward for extending or unloading material (i.e. from a moving floor equipped trailer) or reverse for retracting or loading material. The enclosed electronic controller preferably comprises a pre-programmed non-adjustable electronic controller, electrically interconnected with the embedded electronic piston position sensors and the solenoid-controlled two-way valves. Preferably, the moving floor actuator assembly 102 allows for a moving floor system 100 comprising a minimum of tubes, hoses, tie rods, and other components.

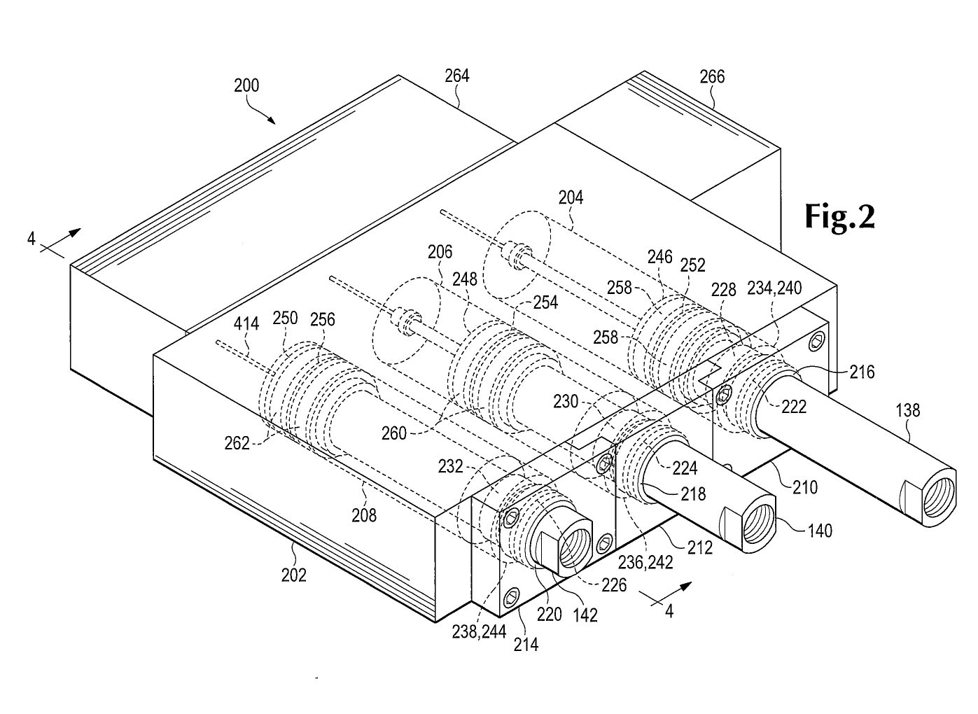

A perspective partially transparent view of an exemplary electro-hydraulic actuator assembly 200 is shown in FIG. 2. In one embodiment, the moving floor actuator 102 comprises, as shown in FIG. 2, an actuator manifold 202, an optional adaptor manifold assembly 266, and a back cover (or rear housing) assembly 264. The back cover assembly 264 preferably encloses and protects electronics associated with the actuator manifold 202 and valving extending from the rear portion of the actuator manifold 202, and the optional adaptor manifold assembly 266 comprises various optional hydraulic circuitry for conditioning hydraulic fluid provided to and received from the actuator assembly 200. The optional adaptor manifold assembly 266, if included, may be attached directly to the actuator manifold 202 as shown, remotely located yet still hydraulically connected to the actuator manifold 202, or integrated within the hydraulic circuitry incorporated within the actuator manifold 202 (with its associated back cover assembly 264).

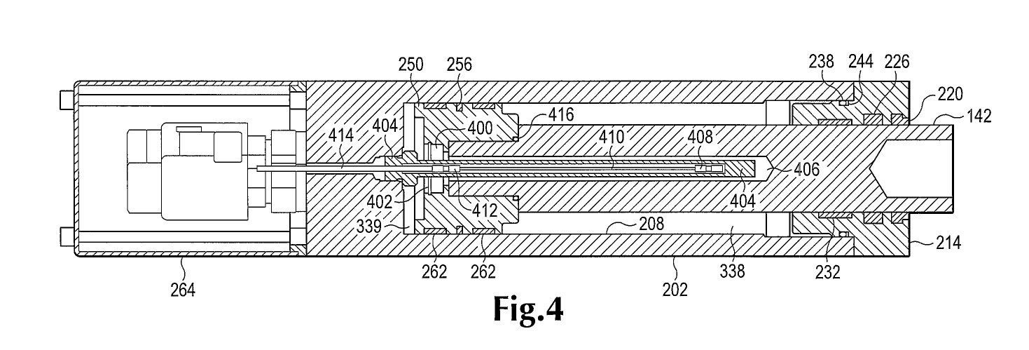

As shown in FIG. 2, the piston rods 138, 140, and 142 extend from the actuator manifold 202 for engagement with cross drives 132, 134, and 136, respectively. The piston rods 138, 140, and 142 are shown longitudinally extensible from within substantially (physically) parallel cylindrical cavities 204, 206, and 208, respectively. The piston rods 138, 140, and 142 are shown inserted into the rod end of the actuator manifold 202 and captured within the actuator manifold 202 by rod-end covers 210, 212, and 214, respectively, which in turn incorporate various seals so as to retain pressurized hydraulic fluid within the rod-end spaces in the cylinder cavities 204, 206, and 208. For example, the rod-end enclosures 210, 212, and 214 are shown with rod wipers 216, 218, and 220, respectively; rod seals 222, 224, and 226, respectively; and rod wearing rings 228, 230, and 232, respectively. Also shown (and shown in more detail in FIG. 4) are o-rings 234, 236, and 238 and backup rings 240, 242, and 244 positioned within appropriately dimensioned glands formed radially within the rod-end enclosures 210, 224, and 226, respectively, so as to provide (static) fluid tight closures for the cylinder cavities 204, 206, and 208.

Pistons 246, 248, and 250 are shown in FIG. 2 in longitudinally staggered positions within respective cylinder cavities 204, 206, and 208, with piston sealing rings 252, 254, and 256, respectively, and each with a pair of piston wear rings 258, 260, and 262, respectively.

Preferably, the manifold 202 comprises an aluminum block within which the cylinder cavities 204, 206, and 208 are machined and within which the pistons and rods and other components are integrally assembled, substantially as shown in FIG. 2. In a less preferred embodiment, the manifold 202 may comprise a housing enclosing individual hydraulic fluid power cylinders assembled within the manifold 202 (instead of the cylinder cavities being machined into the manifold material as shown in FIG. 2). Preferably the back cover assembly 264 provides easy access for servicing or replacement of screw-in, cartridge type hydraulic valves for operation of the cylinders and is sealably closable so as to protect the electronics and valving therewithin from exposure to dirt, debris, and other environmental conditions.

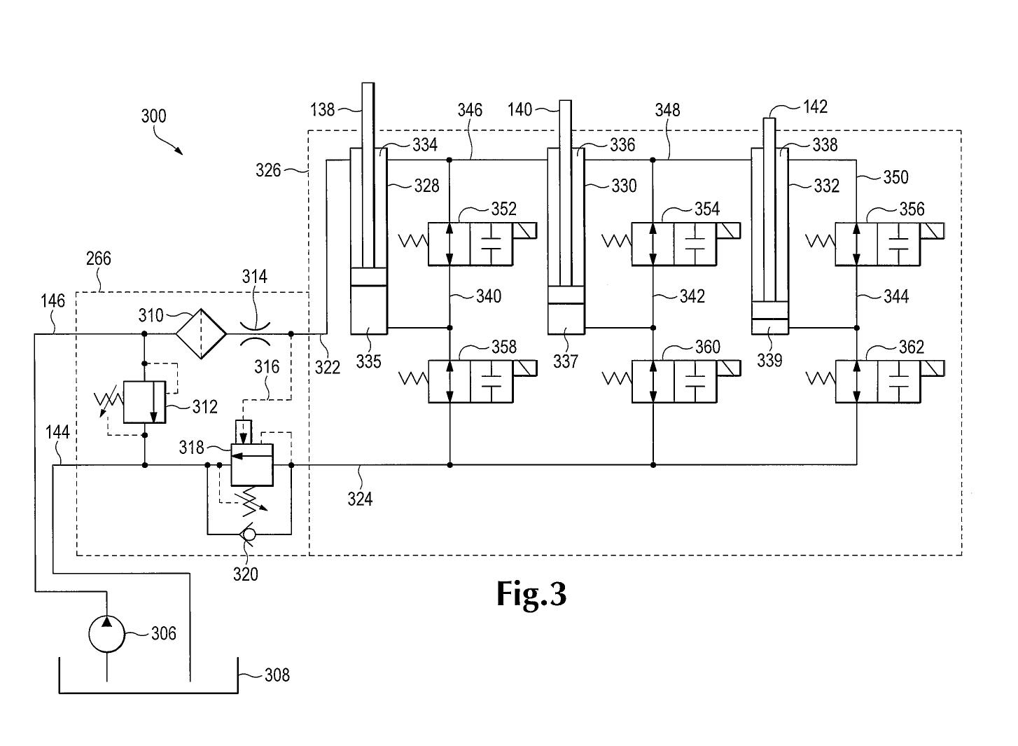

Exemplary hydraulic circuitry for an electro-hydraulic moving floor actuator assembly 300 is shown in FIG. 3, according to various embodiments. The circuitry is shown schematically grouped into circuitry comprising an exemplary optional adaptor manifold assembly 266 and circuitry comprising an exemplary actuator manifold 202 together with valving that may be enclosed or partially housed in a back cover assembly 264 (shown schematically as actuator circuitry 326), although other schematic groupings or arrangements may be used. As shown, pressurized hydraulic fluid may be provided to the optional adaptor manifold 266 via a hydraulic fluid pump 306 and supply line 146, and hydraulic fluid may be exhausted from the optional adaptor manifold 266 via return line 144 (to tank 308).

The optional adaptor manifold assembly 266 preferably comprises various hydraulic circuitry for conditioning the hydraulic fluid provided to the actuator circuitry 326. For example, the optional adaptor manifold assembly 266 may include, sequentially along supply line 146, a pressure regulating valve 312 (or safety relief valve for diverting excess pressure from the supply line 146 to return line 144), a filter or strainer 310, and a flow restrictor (or maximum flow orifice) 314, which when combined condition pressurized hydraulic fluid received into the actuator circuitry 326 via supply line 322. Another suitable type of pressure regulating valve variably responsive to the pressure in line 146 can be used in the position of pressure regulating valve 312, including one or more pilot-controlled relief valves or pressure reducing valves.

The optional adaptor manifold assembly 266 is also shown with a pressure regulating valve 318 and check valve 320 in parallel, which together provide a counterbalance valve (or normally closed pressure control with an integral check valve) between the actuator circuitry 326 return line 324 and return line 144. The pressure regulating valve 318 is shown with a pilot line 316 from supply line 322 that causes 318 to move to an open (or flow) position in response to pressure in supply line 322. In one embodiment, the pressure regulating valve 318 in combination with check valve 320 may operate as a brake valve; pressure in pilot line 316 causes the pressure regulating valve 318 to open, thus allowing hydraulic fluid to freely exhaust from return line 324 (and return line 144), but without pressure in supply line 322, hydraulic pressure upstream (i.e. hydraulic pressure from two-way valves 358, 360, and/or 362) is needed in return line 324 to cause the pressure regulating valve 318 to move to an open (flow) position. In one embodiment, the pressure regulating valve 318 with integral check valve 320 may operate as a meter-out type of flow control circuit, used when a load being moved by cylinders 328, 330, and/or 332 might tend to “run away” or get ahead of hydraulic flow received into the supply line 322. Such meter-out circuitry may be placed between the cylinders 328, 330, and 332 and the reservoir or tank 308 to limit hydraulic fluid flow from the cylinders and received into return line 324.

As shown, the actuator circuitry 326 preferably comprises three hydraulic fluid power cylinders 328, 330, and 332 that are each individually longitudinally extensible between a retracted position and an extended position in response to hydraulic fluid flow controlled by six two-way valves 352, 354, 356, 358, 360, and 362. Each of the power cylinders 328, 330, and 332 has a rod side 334, 336, and 338, respectively, in fluid communication with hydraulic fluid provided by supply line 322. That is, as shown in FIG. 3, supply line (or conduit) 322 is in fluid communication with rod side 334, conduit 346, rod side 336, conduit 348, rod side 338, and conduit 350, although the conduits 346, 348, and 350 may physically comprise a single hydraulic fluid bus or conduit machined into the actuator manifold 202 and further machined so as to fluidly interconnect with the rod sides 334, 336, and 338 of the cylinders 328, 330, and 332, respectively, and fluidly interconnect with the actuator circuitry 326 supply line 322. Each of the power cylinders 328, 330, and 332 has a two-way valve 352, 354, and 356, respectively, permitting hydraulic fluid flow between the power cylinder's rod side 334, 336, and 338, respectively, and the power cylinder's head side 335, 337, and 339, respectively. Further, each of the power cylinders 328, 330, and 332 has a two-way valve 358, 360, and 362, respectively, permitting hydraulic fluid to exhaust through return line 324. The actuator circuitry 326, as shown, allows for a simpler, more compact manifold design, requiring a minimum number of valves (i.e. two) to control each cylinder. The result is a smaller, lighter weight manifold with fewer failure modes and lower manufacturing and ongoing servicing and maintenance costs.

The actuator circuitry 326 may be described as three cylinder sub-circuits interconnected (hydraulically) in parallel, with each cylinder sub-circuit comprising a cylinder with its rod side in fluid communication with the actuator circuitry supply line, a two-way valve interconnecting the rod side and the head side of the cylinder, and a two-way valve interconnecting the head side of the cylinder and the actuator circuitry return line. As shown in FIG. 3, a first cylinder sub-circuit may be defined comprising the cylinder 328 with its rod side 334 in fluid communication with the actuator circuitry supply line 322, the two-way valve 352 interconnecting the rod side 334 (via conduit 346) and the head side 335 (via conduit 340) of the cylinder 328, and a two-way valve 358 interconnecting the head side 335 (via conduit 340) of the cylinder 328 and the actuator circuitry 326 return line 324. The first cylinder sub-circuit is shown interconnected in parallel with both a second cylinder sub-circuit and a third cylinder sub-circuit. The second cylinder sub-circuit may be defined comprising the cylinder 330 with its rod side 336 in fluid communication with the actuator circuitry supply line 322 (shown via conduit 346 and rod side 334), the two-way valve 354 interconnecting the rod side 336 (via conduit 348) and the head side 337 (via conduit 342) of the cylinder 330, and a two-way valve 360 interconnecting the head side 337 (via conduit 342) of the cylinder 330 and the actuator circuitry 326 return line 324. In similar fashion, the third cylinder sub-circuit may be defined comprising the cylinder 332 with its rod side 338 in fluid communication with the actuator circuitry supply line 322 (shown via conduit 348, rod side 336, conduit 346, and rod side 334), the two-way valve 356 interconnecting the rod side 338 (via conduit 350) and the head side 339 (via conduit 344) of the cylinder 332, and a two-way valve 362 interconnecting the head side 339 (via conduit 344) of the cylinder 332 and the actuator circuitry 326 return line 324. Although circuitry for a three-cylinder actuator is shown in FIG. 3, additional cylinder sub-circuits may be included for moving floor systems having more than three groups of interconnected, movable slats. Likewise, fewer sub-circuits than shown in FIG. 3 may be used for moving floor systems having fewer than three groups of interconnected, movable slats. The actuator circuitry 326 is therefore scalable to accommodate different types of moving floor systems.

Preferably, each of the power cylinders 328, 330, and 332 is interconnected as shown so that pressurized hydraulic fluid acts upon one side of the cylinder when both extending and retracting the cylinder. For example, the power cylinders 328, 330, and 332 are shown in FIG. 3 as being interconnected so that pressurized hydraulic fluid acts upon their rod sides 334, 336, and 338, respectively, when both extending and retracting the cylinders. Also shown schematically, each of the hydraulic fluid power cylinders 328, 330, and 332 is preferably a double acting, single end rod fluid power device with a predetermined relationship between rod diameter and cylinder bore diameter. When extending a cylinder, for example, cylinder 328, pressurized hydraulic fluid from supply line 322 acts upon both the rod side 334 and (through two-way valve 352) the head side 335, and the larger surface area of the piston exposed to the pressurized fluid in the head side 335 as compared to the surface area of the piston in the rod side 334 causes extension of the rod 138 and flow of hydraulic fluid from the rod side 334 to the head side 335. The actuator circuitry 326 requires less hydraulic fluid (i.e. oil) for extension of the cylinder because fluid for extending the cylinder is supplied by the head side of the cylinder (as well as from supply line 322 if needed). The reduced fluid requirement in turn allows for the use of a smaller displacement pump 306 and smaller capacity fluid lines in such as system 300. A smaller displacement pump also decreases the horsepower and energy/fuel requirements associated with the pump and its operation. When retracting the cylinder 328 pressurized hydraulic fluid from supply line 322 acts upon the rod side 334, but the flow through the two-way valve 352 is blocked and hydraulic fluid is allowed to exhaust from the head side 335 (through two-way valve 358) to the return line 324.

Preferably, rod diameter and cylinder bore diameter are determined so as to approximately match extending and retracting forces. For example, according to a preferred embodiment, the diameter of rod 138 is two inches, the diameter of the cylindrical cavity 204 for cylinder 328 is three inches, and an operating pressure of 3000 psi (pounds-per-square-inch (gage)) is used to extend and then retract cylinder 328. To extend cylinder 328, all of the two-way valves (i.e. two-way valves 354, 356, 358, 360, and 362) are held in a closed (no flow) position, with the two-way valve 352 held in an open (flow) position so that pressurized hydraulic fluid at 3000 psi acts upon both the rod side 334 and head side 335 of cylinder 328 simultaneously. The pressure on both sides of the piston (i.e. piston 246) will balance each other except for the area of the rod 138. The net force that cylinder 328 will produce when extending is, therefore, the area of the rod times pressure. The area of the rod is approximately 3.14159 times the radius of the rod 138 (i.e. half of the diameter of rod 138) squared, or 3.14159 square inches. The area of the rod times the operating pressure gives a net force during extension of cylinder 328 of approximately 9,425 pounds. The cylinders 330 and 332 are preferably similar to the cylinder 328, and, therefore, the net force during extension of all three cylinders together is approximately three times that of cylinder 328 alone, or 28,275 pounds.

To retract cylinder 328, the two-way valve 352 is moved to a closed (no flow) position blocking fluid flow between the rod side 334 and the head side 335, the two-way valve 358 is moved to an open (flow) position allowing fluid to exhaust from head side 335 to return line 324, and the remaining two-way valves are held in a closed (no flow) position. The pressure on the rod side 334 will be the operating pressure whereas there will be essentially no pressure on the head side 335. The net force that cylinder 328 will produce when retracting is, therefore, the difference between the areas of the piston and the rod times pressure. The area of the piston is approximately 3.24259 times the radius of the piston (or more accurately the radius of the piston plus radially exposed dimensions of the piston sealing ring 252 and/or piston wear rings 258, or approximately the radius of the cylindrical cavity 204 for cylinder 328) squared, or 7.06858 square inches. Subtracting the area of the rod 138 and multiplying by the operating pressure gives a net force during retraction of cylinder 328 of approximately 11,781 pounds. The cylinders 330 and 332 are preferably similar to the cylinder 328, and, therefore, the net force during retraction of all three cylinders together is approximately 35,343 pounds.

In the above example, the net force during extension (of about 9,425 pounds for each cylinder and 28,275 pounds for all three together) is approximately matched with the net force during retraction (of about 11,781 pounds for each cylinder and 35,343 pounds for all three together). In contrast, hydraulic circuitry (not shown) for actuation of cylinders 328, 330, and 332 (each having, for example, a rod diameter of two inches and a cylinder bore diameter of three inches) whereby the cylinders are extended by providing pressurized hydraulic fluid to only their head sides 335, 337, and 339 (i.e. without pressure being provided to both sides of the respective pistons during extension), provides a net force during extension of about 21,206 pounds (the area of the piston times the pressure, or 7.06858 square inches times 3000 psi) for each cylinder and 63,617 pounds for all three cylinders together, or more than twice the extension forces provided by the hydraulic circuitry shown in FIG. 3. In such (prior) systems, components are subjected to much higher extending forces (relative to retracting forces), which may lead to component damage such as, for example, failure of smaller diameter piston rods (which are subjected to twice the force when extending as they are when retracting). The actuator circuitry 326 allows for larger rod diameters (relative to cylinder bore diameter) to be used and for the rod and cylinder bore diameters to be chosen so as to more closely match cylinder extension and retraction forces, thereby reducing potential component shock and subsequent damage.

Different rod and cylinder bore diameters may be used for the actuator circuitry 326 in FIG. 3. For example, in another preferred embodiment, the power cylinders 328, 330, and 332 each have a rod diameter of 1.375 inches and a cylinder bore diameter of two inches, providing a net force during extension of all three cylinders together of approximately 13,364 pounds and a net force of retraction of 14,910 pounds. In yet another preferred embodiment, power cylinders 328, 330, and 332 each have a rod diameter of 3.5 inches and a cylinder bore diameter of five inches, providing a net force of extension for all three cylinders together of approximately 86,590 pounds and a net force of retraction of 90,125 pounds. The rod and cylinder bore diameters may be chosen so as to more closely match extending and retracting forces. For instance, with the area of the piston approximately equal to twice the area of the rod (or, differently stated, with the rod diameter approximately equal to the piston (or cylinder core) diameter divided by the square root of two), the extending and retracting forces should be approximately the same. For example, a piston (or cylinder bore) diameter of three inches (corresponding to a piston area of 7.06858 square inches) and a rod diameter of approximately 2.12132 inches (corresponding to a rod area of 3.53429 square inches) provides a net force during extension of about (area of rod times pressure) 10,603 pounds and a net force during retraction of about (difference between the areas of the piston and rod times pressure) 10,603 pounds.

As shown schematically in FIG. 3, the two-way valves 352, 354, 356, 358, 360, and 362 are preferably normally open solenoid-controlled bidirectional two-way (i.e. two-connection) on-or-off type (i.e. flow or no flow) hydraulic valves. In a preferred embodiment, electronics for controlling activation and deactivation of the solenoids are enclosed within the actuator manifold 202 and/or back cover (rear housing) 264. In alternate embodiments, other types of two-way valves may be used. For example, the two-way valves 352, 354, 356, 358, 360, and 362 may comprise piloted-operated two-way valves with corresponding hydraulic selector valves and associated hydraulic circuitry for controllably piloting open or closed the two-way valves. Hydraulically or mechanically activated two-way valves may be used in less preferred embodiments instead of or in combination with solenoid-controlled valves.

Typical operation of a slat-type moving floor system 100 incorporating the hydraulic circuitry shown in FIG. 3 to, for example, unload material from a trailer equipped with the moving floor system preferably includes extending all of the cylinders 328, 330, and 332 in unison so as to move the respective rods 138, 140, and 142, their respective cross-drives 132, 134, and 136, and their respective groups of interconnected slats forward and thereby moving the material forward (i.e. unloading the trailer by moving the load outward toward an open end of the trailer). To extend all of the cylinders 328, 330, and 332 the two-way valves 352, 354, and 356 are opened to allow fluid flow between the rod sides 334, 336, and 338 and the head sides 335, 337, and 339, and the two-way valves 358, 360, and 362 are closed to block fluid from exhausting to return line 324. Following extension of all three cylinders 328, 330, and 332, each of the cylinders is retracted individually, one at a time until all three cylinders are fully retracted. Once all three cylinders are retracted, the sequence is repeated until the load is fully expelled from the trailer. Retracting cylinder 328 individually may be accomplished by closing all of the two-way valves except the two-way valve 358, which is opened to allow hydraulic fluid to exhaust from head side 335 as pressurized hydraulic fluid is received into the rod side 334 of the cylinder 328. In similar fashion, retracting cylinder 330 may be accomplished by closing all of the two-way valves except the two-way valve 360, which his opened to allow hydraulic fluid to exhaust from head side 337. Likewise, retracting cylinder 332 may be accomplished by closing all of the two-way valves except the two-way valve 362, which is opened to allow hydraulic fluid to exhaust from head side 339.

The slat-type moving floor system 100 incorporating the hydraulic circuitry shown in FIG. 3 may be operated in reverse to, for example, load material into a trailer equipped with the moving floor system. The floor slats may be retracted all together in unison by retracting all three of the cylinders 328, 330, and 332, which may be accomplished by closing the two-way valves 352, 354, and 356 and opening the two-way valves 358, 360, and 362 to allow hydraulic fluid to exhaust from the head sides 335, 337, and 339 as pressurized hydraulic fluid is received into the rod sides 334, 336, and 338 of the cylinders 328, 330, and 332, respectively. Once all three cylinders 328, 330, and 332 are fully retracted, each of the cylinders is then extended one at a time until all three cylinders are fully extended. The sequence is repeated until the load is conveyed into the trailer to the desired position. Extending cylinder 328 individually may be accomplished by closing all of the two-way valves except the two-way valve 352, which is opened to allow hydraulic fluid to flow from the rod side 334 to the head side 335 of the cylinder 328. In similar fashion, extending cylinder 330 may be accomplished by closing all of the two-way valves except the two-way valve 354, which is opened to allow hydraulic fluid to flow from the rod side 336 to the head side 337. Likewise, extending cylinder 332 may be accomplished by closing all of the two-way valves except the two-way valve 356, which is opened to allow hydraulic fluid to flow from the rod side 338 to the head side 339.

In preferred embodiments, the moving floor system 100 provides a load travel speed (i.e. the speed that the load travels longitudinally along the slat-type floor) of approximately ten feet per minute using cylinders 328, 330, and 332 that provide approximately six inches of cylinder stroke (i.e. the longitudinal travel distance between their fully retracted and fully extended positions) and hydraulic fluid supplied by a pump (such as pump 306) at a rate of about eleven gallons per minute for a system comprising cylinders 328, 330, and 332 having rod diameters of approximately two inches and cylinder bore diameters of approximately three inches; at a rate of about 4.9 gallons per minute for a system comprising cylinders 328, 330, and 332 having rod diameters of approximately 1.375 inches and cylinder bore diameters of approximately two inches; and at a rate of about 30.6 gallons per minute for a system comprising cylinders 328, 330, and 332 having rod diameters of approximately 3.5 inches and cylinder bore diameters of approximately five inches.

In preferred embodiments, each of the cylinders 328, 330, and 332 have a cross-section similar to that shown in FIG. 4, which is a cross-sectional view through longitudinal cut line 4-4 in FIG. 2. As shown, the piston 250 is fastened to the head end of the rod 142 and sealed via piston o-ring 416. The cylinder preferably includes a limit switch assembly comprising a limit switch housing 404, which encapsulates an end-of-extension switch element 408 (such as, for example, a reed switch or other type of proximity type), one or more electrical conductor 410 from the end-of-extension switch element 408, an end-of-retraction switch element 412 (of similar type as the end-of-extension switch element 408), and electrical conductors 414 from the switch elements 408 and 412. As shown, the limit switch housing 404 is inserted within a limit switch cavity 406 machined through the piston 250 and head end of the rod 142 and mounted within the cylinder cavity 208 so as to remain fixed in relation to the cylinder cavity 208 throughout longitudinally extensible movement of the rod 142 and piston 250, which is shown in FIG. 4 in a fully retracted position. A magnet 400 or other type of proximity switch target is preferably incorporated into the piston 250, shown retained by a snap ring 402, for triggering the end-of-retraction switch element 412 when the piston 250 is in a fully retracted position and triggering the end-of-extension switch element 408 when the piston 250 is in a fully extended position. Electronic controls housed within the back cover 264 (or elsewhere) receive electrical signals from the switch elements 412 and 408 for determining rod/piston position and electronic control of the solenoid-controlled two-way valves 352, 354, 356, 358, 360, and 362. For example, the two-way valves 352, 354, and 356 are activated to a closed position to stop further extension of the respective rods 138, 140, and 142 once the respective end-of-extension switch elements electrically sense the magnets (or proximity switch targets) incorporated into the respective piston 246, 248, and 250, thus eliminating mechanical end-of-stroke induced shock and mechanical stress therefrom. The electronic controls preferably use the embedded electronic piston position sensors (i.e. the end-of-extension and end-of-retraction switch elements and targets) in each cylinder to prevent the pistons from being mechanically stopped within their respective cylinder cavities, thus reducing component wear and tear and the potential for hydraulic fluid leaks. Further, sensing end-of-stroke electronically (using sensor switches embedded internally to the cylinder, piston, and rods, as shown in FIG. 4, or, alternatively, using similar sensor switches embedded elsewhere in the manifold 202 oriented to sense end-of-extension and end-of-retraction) instead of mechanically (perhaps by triggering end-of-stroke when a mechanical member attached to a moving component physically contacts another mechanical component) provides for quieter actuator operation.

Electronic piston position sensing afforded by the internally oriented switches (such as the switch elements 412 and 408) provides position information that is preferably used to automatically detect jamming conditions in any of the cylinders 328, 330, and 332 and to subsequently automatically reverse direction of the affected cylinders for clearing the jamming conditions. For example, electronics associated with the moving floor actuator assembly 102 (i.e. included within the manifold 202 and/or rear housing 264, and/or as part of the control console 108) preferably monitor the position sensors within the cylinders 328, 330, and 332 (such as the switch elements 412 and 408) and detect when any of the cylinders become jammed, which may be indicated when, for instance, an end-of-extension switch triggering event was expected but did not happen within a prescribed amount of time or not at all. In response to the jamming condition, the particular cylinder(s) involved is(are) automatically reversed momentarily so as to clear the jamming condition. When material becomes jammed between adjacent floor slats, reversing the direction of the reciprocating slats may dislodge the problem causing material so that reciprocation of the moving floor slats may be resumed to advance the load in the direction of desired travel (i.e. to continue unloading a trailer).

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A hydraulic moving floor actuator in a slat-type moving floor system having movable floor slats arranged side-by-side in parallel, with each slat extending longitudinally along a conveyance path and interconnected with other slats to form groups of slats which may be longitudinally extended or retracted along said conveyance path in unison or one group at a time, said actuator comprising:
(a) a longitudinally extensible hydraulic fluid power cylinder for each one of said groups of slats, each cylinder having a rod side with a rod extending longitudinally therefrom, and a head side opposite said rod side, said rod interconnected with a respective one of said groups of slats; and
(b) hydraulic circuitry for each cylinder providing fluid communication between said rod side and said head side of each cylinder and adapted to cause longitudinal extension of said cylinder by providing pressurized hydraulic fluid simultaneously to both said rod and head sides.

2. The actuator as in claim 1 further comprising electro-hydraulic circuitry and electronic controls adapted for sequentially longitudinally extending more than one group of slats in unison, followed by retracting one group of slats at a time until all extended slats have been retracted, and repeating said extending and retracting sequence so as to move a load resting upon said movable slats forward along said conveyance path.

3. The actuator as in claim 2 further comprising, without additional longitudinally extensible fluid power cylinders, electro-hydraulic circuitry and electronic controls adapted for operating said actuator in reverse, sequentially longitudinally retracting more than one group of slats in unison, followed by extending one group of slats at a time until all retracted slats have been extended, and repeating said retracting and extending sequence so as to move said load resting upon said movable slats back along said conveyance path.

4. The actuator as in claim 3 wherein each of said cylinders, said electronic controls, and said electro-hydraulic circuitry are enclosed within a substantially integrated, unitary manifold.

5. The actuator as in claim 1 wherein each of said longitudinally extensible hydraulic power cylinders and said hydraulic circuitry are enclosed within a substantially integrated, unitary manifold.

6. The actuator as in claim 1 further comprising, for each cylinder, a predetermined relationship between rod diameter and cylinder bore diameter so as to approximately match cylinder extending and retracting forces.

7. The actuator as in claim 1 further comprising electronic piston position sensors for each cylinder, said position sensors adapted to indicate when said cylinder is extended or retracted so as to prevent mechanical stoppage at said cylinder's end-of-stroke.

8. The actuator as in claim 7 wherein said electronic piston position sensors are embedded internally within each cylinder and its piston and rod therewith.

9. The actuator as in claim 7 further comprising:
(a) without additional longitudinally extensible fluid power cylinders, electro-hydraulic circuitry and electronic controls adapted for operating said actuator in reverse, sequentially longitudinally retracting more than one group of slats in unison, followed by extending one group of slats at a time until all retracted slats have been extended, and repeating said retracting and extending sequence so as to move a load resting upon said movable slats back along said conveyance path; and
(b) said electronic controls further adapted for automatically detecting a jamming condition using said electronic piston position sensors and, in response, automatically reversing operation of said actuator to clear said detected jamming condition.

10. A hydraulic moving floor actuator in a slat-type moving floor system having movable floor slats arranged side-by-side in parallel, with each slat extending longitudinally along a conveyance path and interconnected with other slats to form groups of slats which may be longitudinally extended or retracted along said conveyance path in unison or one group at a time, said actuator comprising:
(a) a longitudinally extensible hydraulic fluid power cylinder for each one of said groups of slats, each cylinder having a rod side with a rod extending longitudinally therefrom, and a head side opposite said rod side, said rod interconnected with a respective one of said groups of slats; and
(b) hydraulic sub-circuitry for each cylinder fluidly interconnected to one another in parallel, with each cylinder sub-circuitry comprising one of said cylinders with its rod side in fluid communication with an actuator circuitry supply line, a valve fluidly interconnecting said one of said cylinders' rod and head sides, and a valve fluidly interconnecting said one of said cylinders' head side and an actuator circuitry return line.

11. The actuator as in claim 10 further comprising electro-hydraulic circuitry and electronic controls adapted for sequentially longitudinally extending more than one group of slats in unison, followed by retracting one group of slats at a time until all extended slats have been retracted, and repeating said extending and retracting sequence so as to move a load resting upon said movable slats forward along said conveyance path.

12. The actuator as in claim 11 further comprising, without additional longitudinally extensible fluid power cylinders, electro-hydraulic circuitry and electronic controls adapted for operating said actuator in reverse, sequentially longitudinally retracting more than one group of slats in unison, followed by extending one group of slats at a time until all retracted slats have been extended, and repeating said retracting and extending sequence so as to move said load resting upon said movable slats back along said conveyance path.

13. The actuator as in claim 12 wherein each of said cylinders, said electronic controls, and said electro-hydraulic circuitry are enclosed within a substantially integrated, unitary manifold.

14. The actuator as in claim 10 wherein each of said longitudinally extensible hydraulic power cylinders and said hydraulic circuitry are enclosed within a substantially integrated, unitary manifold.

15. The actuator as in claim 10 further comprising, for each cylinder, a predetermined relationship between rod diameter and cylinder bore diameter so as to approximately match cylinder extending and retracting forces.

16. The actuator as in claim 10 further comprising electronic piston position sensors for each cylinder, said position sensors adapted to indicate when said cylinder is extended or retracted so as to prevent mechanical stoppage at said cylinder's end-of-stroke.

17. The actuator as in claim 16 wherein said electronic piston position sensors are embedded internally within each cylinder and its piston and rod therewith.

18. The actuator as in claim 16 further comprising:
(a) without additional longitudinally extensible fluid power cylinders, electro-hydraulic circuitry and electronic controls adapted for operating said actuator in reverse, sequentially longitudinally retracting more than one group of slats in unison, followed by extending one group of slats at a time until all retracted slats have been extended, and repeating said retracting and extending sequence so as to move a load resting upon said movable slats back along said conveyance path; and
(b) said electronic controls further adapted for automatically detecting a jamming condition using said electronic piston position sensors and, in response, automatically reversing operation of said actuator to clear said detected jamming condition.

19. A hydraulic moving floor actuator in a slat-type moving floor system having movable floor slats arranged side-by-side in parallel, with each slat extending longitudinally along a conveyance path and interconnected with other slats to form three groups of slats which may be longitudinally extended or retracted along said conveyance path in unison or one group at a time, said actuator comprising:
(a) three longitudinally extensible hydraulic fluid power cylinders, one cylinder for each one of said three groups of slats, each cylinder having a rod side with a rod extending longitudinally therefrom and a head side opposite said rod side, said rod interconnected with a respective one of said three groups of slats; and
(b) three cylinder sub-circuits fluidly interconnected to one another in parallel, with each cylinder sub-circuit having one of said cylinders with its rod side in fluid communication with an actuator circuitry supply line, a valve fluidly interconnecting said one of said cylinders' rod and head sides, and a valve fluidly interconnecting said one of said cylinders' head side and an actuator circuitry return line.

20. The actuator as in claim 19 further comprising:
(a) electronic piston position sensors for each cylinder, said position sensors adapted to indicate when said cylinder is extended or retracted so as to prevent mechanical stoppage at said cylinder's end-of-stroke;
(b) electro-hydraulic circuitry and electronic controls adapted for sequentially longitudinally extending all three groups of slats in unison, followed by retracting one group of slats at a time until all extended slats have been retracted, and repeating said extending and retracting sequence so as to move a load resting upon said movable slats forward along said conveyance path;
(c) without additional longitudinally extensible fluid power cylinders, electro-hydraulic circuitry and electronic controls adapted for operating said actuator in reverse, sequentially longitudinally retracting all three groups of slats in unison, followed by extending one group of slats at a time until all retracted slats have been extended, and repeating said retracting and extending sequence so as to move said load resting upon said movable slats back along said conveyance path; and
(d) said electronic controls further adapted for automatically detecting a jamming condition using said electronic piston position sensors and, in response, automatically reversing operation of said actuator to clear said detected jamming condition.
